(19) United States
(12) Patent Application Publication
(10) Pub. No.: US 2011/0278235 A1
(43) Pub. Date: Nov. 17, 2011

(54) EcoSafe Desal Intake System

(76) Inventor: Benjamin Blumenthal, Atlanta, GA (US)

(21) Appl. No.: 12/781,301

(22) Filed: May 17, 2010

(51) Int. Cl. E03B 3/04; C02F 1/00

(52) U.S. Cl. 210/747.5; 210/459; 210/170.11

(57) ABSTRACT

Described is a system for creating a microenvironment around a high volume water intake pipe. Specifically, a microenvironment cage incorporating fiber optics, sonar and monitoring sensors may be placed around such a pipe with the express purpose of keeping fish, wildlife and debris away from intake holes and any associated filters. The cage protects marine habitat by keeping the high intake forces away from fish and wildlife and it lowers the energy and maintenance requirements of an associated facility by only allowing water to approach the facility's intake pipe.

### FIELD AND BACKGROUND OF THE INVENTION

The present invention relates to the field of high-volume water intake in general and desalination water intake systems in particular.

Many applications require the movement of large amounts of water, generally from the ocean. Desalination plants, both on land and on the seas, oil rigs, and power generation facilities often move millions of gallons a day, leading to very high flow rates (2 to 8 tons per second) of water. One of the challenges of moving so much water continuously is to keep the water free from fish, jellyfish, other wildlife, seaweed, plastics and other debris.

In the past decade, many industrial processes have been considered for their environmental impact. While desalination facilities are well known “polluters” due to their brine release, they also have issues with respect to the manner in which massive quantities of water are brought into the desalination plants. Massive quantities of water must be moved, but fish, wildlife and debris must be kept out of the facilities where the water is used or processed. Proper filtering of water is a key technology for desalination and other water-based heavy industries as the quality of the intake water directly impacts the costs of operations and the life of the water treatment filters, membranes or other equipment.

U.S. Pat. No. 4,169,792 to Dovel describes a water intake device comprising a substantially cylindrical rotatable screen adapted to be at least partially submerged in a body of water, means for rotating said screen, a water supply conduit communicating with the interior of said screen to receive water flowing through said screen, means for backwashing a section of said screen as said screen moves by said backwashing means so as to clear and/or remove objects or fish caught on the exterior surface of said screen and duct means associated with said backwashing means to provide or define a flow channel or path to guide and/or carry the objects or fish away from the influence or suction of the water entering said screen to said water supply conduit.

U.S. Pat. No. 4,064,048 to Downs et al. teaches an improved water intake system with fish control means includes a watercourse through which water is drawn from a body of water containing fish and debris, a fish diversion structure mounted across the watercourse for diverting fish unavoidably sucked therein and fish removal means located at one end of the fish diversion structure for removing the diverted fish from the water in the watercourse for return to the body of water.

U.S. Pat. No. 4,343,698 to Jackson describes water intake for example for taking cooling water for industrial installations from a river, a lake or the sea, has a sieve with a filter element and a recovery channel associated with the filter element for collecting and saving elements of the biomass which become stuck to the filter element. Electrodes are associated with the recovery channel 25 and are designed to induce an electrical field, at right angles to the recovery channel in the water to be tapped, so as to compel fish either to swim by themselves in the direction of this recovery channel or to allow themselves to be carried towards the recovery channel by a reverse water current induced at right angles thereto.

U.S. Pat. No. 3,850,804 to Taylor teaches a traveling water screen unit comprises an endless series of pivotally interconnected rectangular screens. Each screen comprises a frame having ends attachable to corresponding links of parallel chains and a screen insert which is separately fabricated and secured by bolts between the central horizontal members of the frame. The debris carried by the flow in a channel is intercepted by the lower, upward moving screens and is removed by backwash sprays from the screens approaching the upper drive and support means. Such units and their intermediate support columns may be set flush and in a straight line so that fish are readily diverted away from the screen.

U.S. Pat. No. 5,385,428 to Taft et al. teaches a fish diversion apparatus uses a plane screen to divert fish for variety of types of water intakes in order to protect fish from injury and death. The apparatus permits selection of a relatively small screen angle, for example ten degrees, to minimize fish injury. The apparatus permits selection of a high water velocity, for example ten feet per second, to maximize power generation efficiency. The apparatus is especially suitable retrofit to existing water intakes. The apparatus is modular to allow use plural modules in parallel to adjust for water flow conditions. The apparatus has a floor, two opposite side walls, and a roof which define a water flow passage and a plane screen within the passage. The screen is oriented to divert fish into a fish bypass which carries fish to a safe discharge location. The dimensions of the floor, walls, and roof are selected to define the dimensions of the passage and to permit selection of the screen angle. The floor is bi-level with a level upstream of the screen and a level beneath screen selected to provide a uniform flow distribution through the screen. The apparatus may include separation walls to provide a water flow channel between the apparatus and the water intake. Lead walls may be used to adjust water flow conditions into the apparatus. The apparatus features stoplog guides near its upstream and downstream ends to permit the water flow passage to be dewatered.

### SUMMARY OF THE INVENTION

It is an object of the present invention to provide a controlled microenvironment between a high-throughput water intake pipe and the body of water in which it is located. Specifically, some aspects of the present invention allow for a system and method for protecting fish and other wildlife by keeping them far away from an intake pipe so as to prevent their being sucked up against or into the intake pipe.

The invention includes a water intake system, including the following: a high-volume water intake pipe having at least one hole for taking water into the pipe and leading the water towards an element that makes use of the water; water filters, wherein the water filters are associated with the intake pipe; and, a microenvironment cage, wherein the cage is physically attached to the intake pipe at a plurality of positions and includes opening for water passage from a bulk water source into a microenvironment around the intake pipe.

In one aspect of the system, the bulk water is associated with an ocean or sea.

In another aspect of the system, the element is a desalination facility, oil rig, or power station.

In still another aspect of the system, the desalination facility is associated with a vessel.

In another aspect of the system, the cage is attached to the vessel.

In another aspect of the system, the cage is cube-shaped with edge length at least four meters longer than the diameter of the intake pipe.

In another aspect of the system, the cage is cylindrical and can be rotated.

In another aspect of the system, there is additionally a sonar system associated with said cage for scaring off fish and other wildlife.

In another aspect of the system, there is additionally means of providing light around said cage for repelling fish and other wildlife.

In another aspect of the system, the outer surfaces of the cage are selected to allow for water flow into the microenvironment between the cage and the intake pipe, while fish, debris and other non-water elements are essentially kept out of the microenvironment.

In another aspect of the system, the cage is made of a polymeric material.

In another aspect of the system, the intake pipe is equipped with a plurality of sensors capable of monitoring and reporting the quality of intake water to a central computer.

In another aspect of the system, the intake pipe is a plurality of intake pipes.

The invention includes a method for taking in large amounts of water in an ecologically-friendly manner, including the following: providing an intake pipe having at least one hole for taking water into the pipe and leading the water towards an element that makes use of the water; attaching a water permeable cage around the intake pipe, wherein the cage has an edge length 4 meters longer than the diameter of the intake pipe; placing the intake pipe with the cage into a body of water; and, directing water from the body of water though the cage and into the intake pipe.

In one aspect of the method, the intake pipe is associated with a desalination installation, oil rig, or power station.

In another aspect of the method, the desalination installation is located on a vessel.

In another aspect of the method, the body of water is an ocean or sea.

In another aspect of the method, the cage is built so as to prevent fish, wildlife, plastic and debris from reaching a microenvironment between the cage and the intake pipe.

In another aspect of the method, there is a sonar system associated with said cage for scaring off fish and other wildlife.

In another aspect of the method, there is means of providing light around said cage for repelling fish and other wildlife.

In another aspect of the method, the intake pipe is equipped with a plurality of sensors that monitor and report the quality of the intake water to a central computer.

In another aspect of the method, there is additionally a step of rotating the cage so as to remove debris stuck to the outside of the cage.

The invention also provides for a device for providing an ecologically safe microenvironment around an intake pipe of a desalination plant, including a cage placed around the intake pipe, wherein the cage is physically anchored to the intake pipe and of a design to keep fish, wildlife, plastic and other debris at least four meters from the intake holes of the pipe.

In one aspect of the device, the cage is attached to the intake pipe at a plurality of positions.

In another aspect of the device, the desalination plant is associated with a vessel.

The invention also includes a water intake system, including the following: a high-volume water intake pipe having at least one hole for taking water into the pipe and leading the water towards an element that makes use of the water; water filters, wherein the water filters are associated with the intake pipe; and, a rotation-capable microenvironment cage, wherein the cage is physically attached to the intake pipe at a plurality of positions and includes opening for water passage from a bulk water source into a microenvironment around the intake pipe and further including active sonar and fiber-optic anti-fish elements.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 shows a schematic view of a high-volume intake pipe with a microenvironment cage attached to it;

FIG. 2 shows a schematic view of an alternative cage associated with a high-volume intake pipe;

FIG. 3 shows a potential for rotation of a cage for purposes of self-cleaning;

FIG. 4 shows a schematic view of the present invention associated with a desalination vessel;

FIG. 5 shows a schematic view of the present invention associated with a fixed-location desalination facility;

FIG. 6 shows features of a microenvironment cage according to an embodiment of the present invention; and,

FIG. 7 shows a flowchart for a typical method according to the present invention.

### DETAILED DESCRIPTION OF EMBODIMENTS

### Description of the Preferred Embodiment

In the following description, numerous specific details are set forth in order to provide a thorough understanding of the present invention. It will be apparent, however, to one skilled in the art that the present invention may be practiced without these specific details. In other instances, well-known circuits and control logic have not been shown in detail in order not to unnecessarily obscure the present invention. The following definitions are for aiding in understanding the present invention.

### DEFINITIONS

Certain terms are now defined in order to facilitate better understanding of the present invention.

Many terms will have their generally accepted meanings within the context of the present invention. “Desalination”, “oil rig”, “fish”, and other terms not specifically defined otherwise may have their generally accepted meaning.

“Intake pipe”, “high volume water intake pipe” or “high volume intake pipe” may refer to a conduit, made of any material that can move large volumes of a liquid, generally water, from a first location to a second location. First location is generally a body of water, such an ocean or lake, while second location is generally an element that makes use of such water, such as a desalination plant, a cooling tower, or an oil rig. Intake pipes generally have flow levels measured in millions of gallons per day. “Intake holes” refer to holes in an intake pipe through which water flows into the intake pipe.

“Intake water” may refer to the water taken in by an intake pipe.

An “anti-fish” element is a device or the like the scares away or repels fish. Some sonar or light-based devices are known to have properties that can repel fish and as such may be useful as elements decorated on or attached to a microenvironment cage.

Many large-scale industrial applications require the movement of enormous quantities of water, generally from lakes or oceans. The movement of so much water necessarily creates forces that pull fish, wildlife and debris towards the intake holes of an intake pipe. Though intake holes generally include sophisticated filters, the pull can lead to the death of fish and wildlife as well as the fouling of filters due to the pull of non-water debris. One of the purposes of the present invention is to create a controlled and monitored microenvironment around intake holes of an intake pipe, so that the volume in which high suction forces exist is closed off to fish, wildlife and water-borne debris. By doing so, the invention allows for cleaner water intake, lowered costs due to fewer filter and membrane replacements, as well as a higher degree of protection of wildlife, fish and the submarine ecosystem, which are no longer exposed to the forces pulling tons of water per second towards a desalination plant or cooling tower.

The present invention includes a microenvironment cage that is fastened—either permanently or transiently—to a portion of an intake pipe. The cage is positioned and designed to allow for water flow from bulk water (ocean, sea, lake) into the microenvironment and into the intake pipe, while keeping out fish, wildlife, plastic, and other debris. Features such as fiber optic cables and sonar technology enhance fish repelling to further reduce damage to water ecosystems in the presence of high water flux.

### First Embodiment

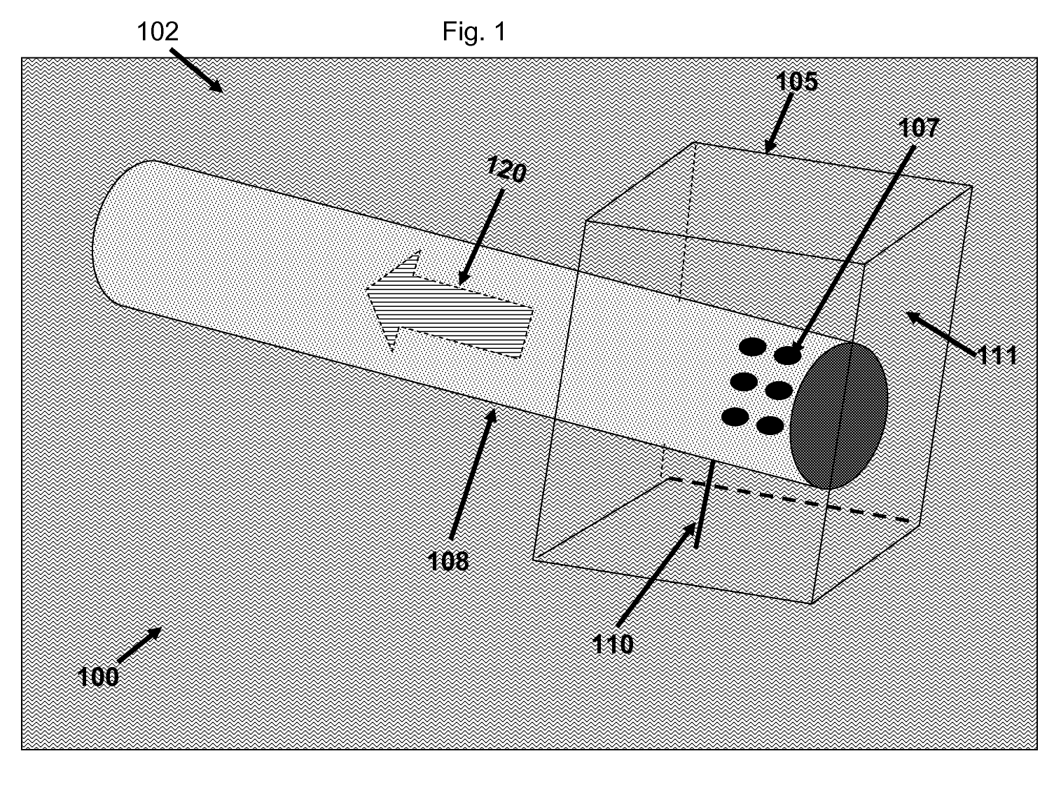

Attention is turned to FIG. 1, which shows a schematic embodiment of a high volume water inlet system 100. The system 100 is located in a body of water 102 and includes a microenvironment cage 105 placed around the inlet holes 107 of an intake pipe 108 or the like. Water flows from the body of water 102 towards an element (not shown) that makes use of the water (see arrow 120 for direction). One or more supports 110 (only one shown for clarity in FIG. 1) attaches the microenvironment cage 105 to the intake pipe 108. It is understood that this attachment may be transient or permanent. Supports 110 may additionally or alternatively attach a microenvironment cage 105 to another element such as a desalination facility or oil rig (not shown).

FIG. 1 shows a most basic set-up of an embodiment of the present invention. Intake pipe 108 may move millions of gallons of water for desalination, cooling, or other purposes. While intake holes 107 will have filtering systems (not shown) associated with them, the sheer force of pushing tons of water per second will necessarily both damage the marine habitat around the intake pipe 108 as well as lead to rapid fouling of filters due to the pull of fish, wildlife, plastic and other debris. With filters clogged, more energy is expended to move the same amount of water, and when debris bypasses the traditional filters, desalination and other facilities harm the submarine ecosystem and work less efficiently over time.

The microenvironment cage 105 addresses many of these problems. While not shown, the cage has an outer surface that includes many small holes. These holes allow the facile passage of water but necessarily keep fish, wildlife and debris away from the intake holes 107 and any associated filtering mechanisms. Additionally, the microenvironment cage 105 is sized so as to prevent the marine habitat outside of the cage from experiencing the massive pull of thousand of liters per second of water. The overall effect is to both protect the environment in which the intake pipe 108 is active as well as to allow for greater energy efficiency by keeping blocking agents (fish, debris, etc.) away from the filters and further away from elements such as a desalination plant, oil rig, or cooling tower.

It is understood that the microenvironment cage 105 can be of any shape and made of any appropriate material. The cage will generally have outer edges 111 four or more meters away from intake holes 107 so as to reduce significantly reduce the effects of the water intake pull. This size can be modified, depending on the specific location as well as the rate of water intake (the greater, the bigger the cage, in general). Additionally, materials used in cage construction and action can be modified according to water body 102 details—salt or sweet, temperature, depth, wildlife generally present, etc.

### Second Embodiment

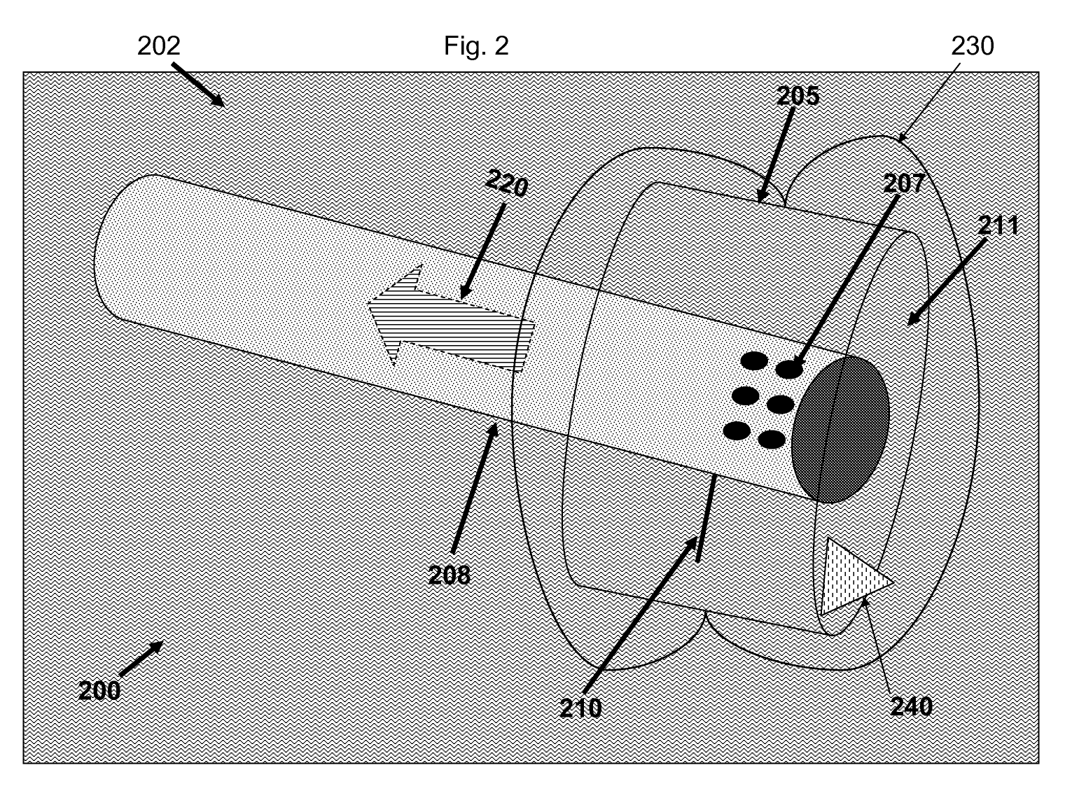

Attention is now turned to FIG. 2 which shows an alternative embodiment of the present invention. Similar elements are advanced by 100 from their corresponding elements in FIG. 1. A high-volume water inlet system 200 includes an intake pipe 208 and microenvironment cage 205. The cage is cylindrical, as shown, and further includes a fiber optic cable 230 and sonar system 240 for keeping fish and wildlife away from the microenvironment cage 205 and inlet holes 207. Sonar has been shown to affect fish behavior and light provided through the optic cable 230 also can be used to scare away fish and other wildlife. An additional use of the optic cable 230 could be to provide video information in regards to the area around microenvironment cage 205 which acts as a super pre-filter between a body of water 202 and an element (not shown) which makes use of the water (as suggested by flow arrow 220) taken into the inlet pipe 208. As such, a control room could monitor the conditions around an inlet pipe 208 via the fiber optic cable 230 and any associated camera or video elements (not shown separately).

In this embodiment, active elements such as the sonar system 240 and fiber optic cable 230 are used to keep fish and wildlife from getting near the microenvironment cage 205. By keeping the fish at a distance, there is less fouling on the cage surface 211 and less likelihood that even smaller species such as plankton could get through the cage and to the inlet holes 207. Supports 210 that anchor the microenvironment cage 205 to the intake pipe 208 may include sonar, optic, electric or other elements provide for further marine habitat safety away from the massive pull of the high-volume intake pipe 208.

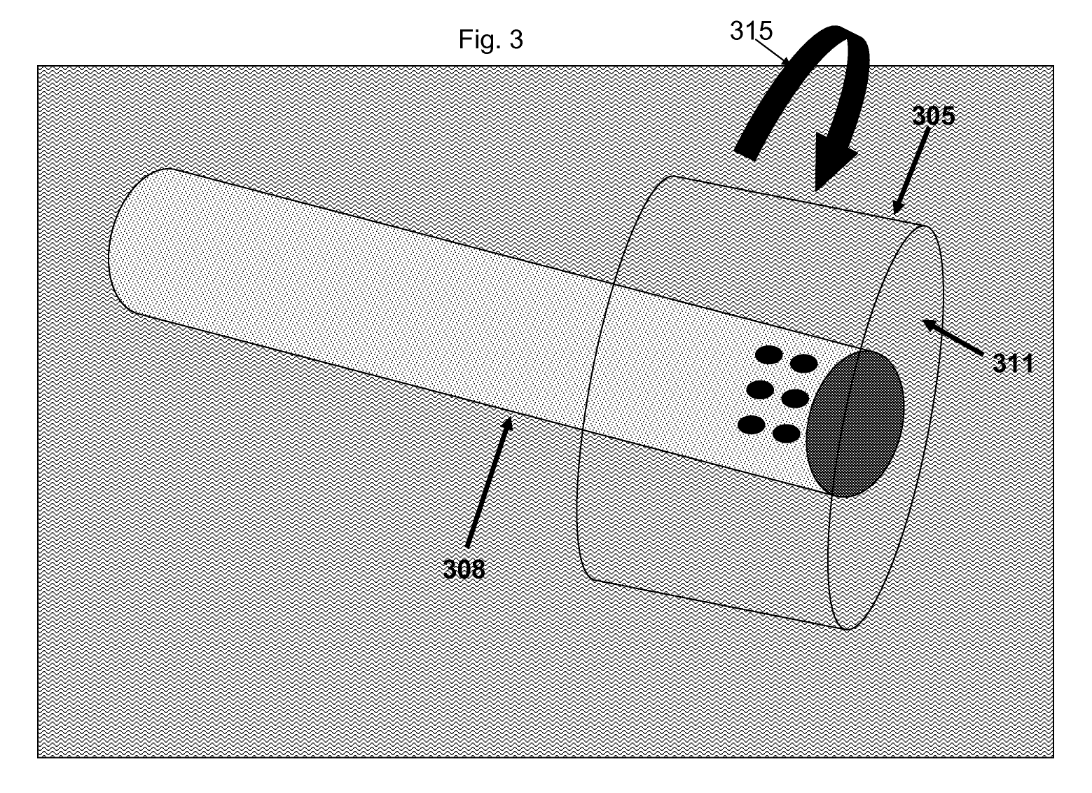

FIG. 3 shows the microenvironment cage 305 rotating (as suggested by arrow 315) relative to the intake pipe 308. This rotation may be done periodically to clean the surface 311 of the cage or alternatively, rotation can be a constant feature, so as to further reduce fish penetration of microenvironment cage 305. For purposes of clarity, only a minimal number of elements are displayed in FIG. 3.

Electricity or other energy for rotation of the microenvironment cage 305 or for powering optic cable (FIG. 2, 230) or sonar system (FIG. 2, 240) or the like may be provided by batteries, the element to which water is supplied (such as a desalination plant or oil rig) or other appropriate energy source.

### Third Embodiment

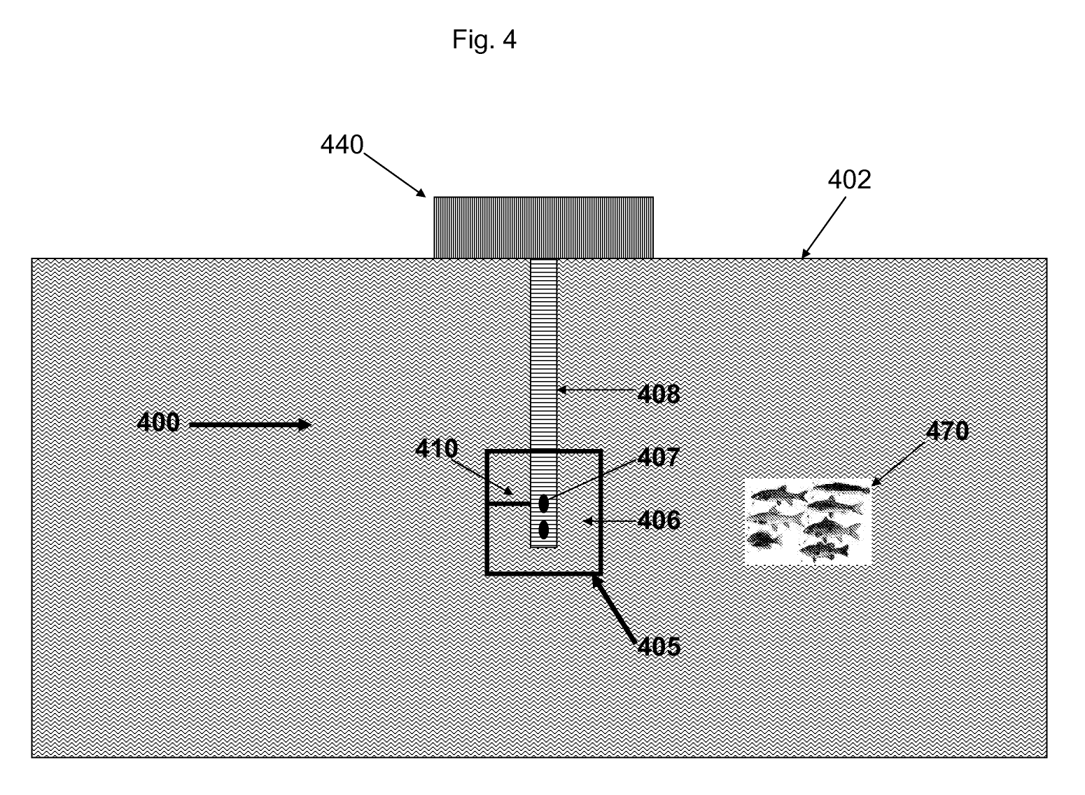

Attention is turned to FIG. 4 which shows a high volume water inlet system 400 deployed with a desalination plant 440. Desalination plants typically convert millions of gallons per day of undrinkable water into potable water and concentrated brine. Desalination plants are notorious for environmental damage, due both to water intake as well as brine return. In the embodiment shown here, the desalination plant 440 is associated with a vessel and thus can move from location to location. The desalination plant 440 has at least one inlet pipe 408 that includes inlet holes 407 that allow sea water 402 to be brought into the plant and processed into drinking water. Around the inlet holes 407 is placed a microenvironment cage 405 with at least one support 410 connecting microenvironment cage 405 and inlet pipe 408. The microenvironment cage is made of material and is of shape to prevent fish 470, wildlife, plastic and other debris from traveling from the bulk sea water 402 to the microenvironment 406 created between the microenvironment cage 405 and the inlet holes 407. This arrangement of elements allows for high-volume water intake with minimal disturbance of local marine habitat. As such, it addresses one of the two major environmental problems associated with desalination: location-friendly intake of massive quantities of sea water 402.

### Fourth Embodiment

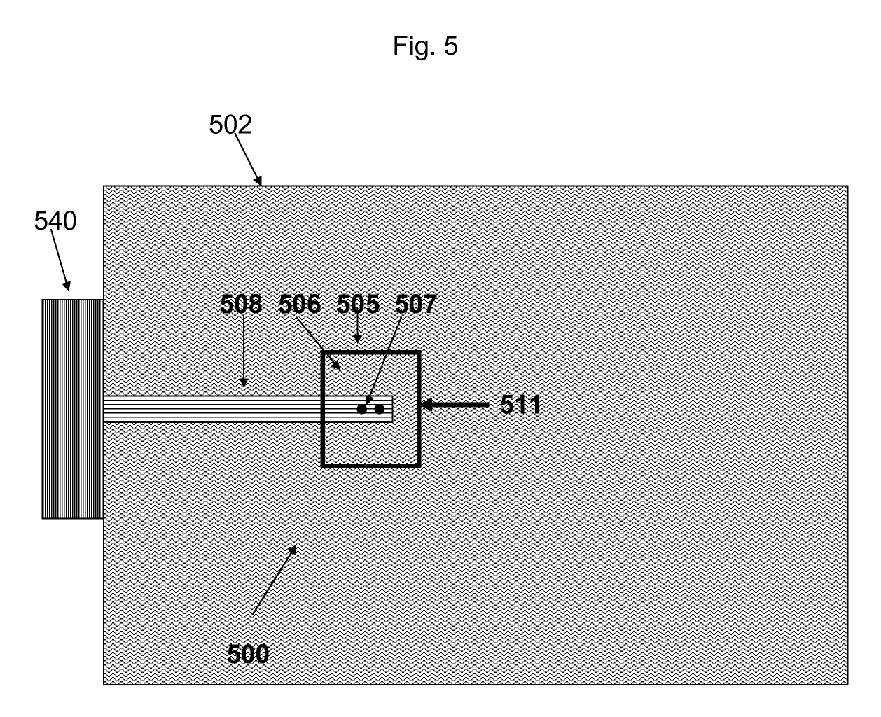

Attention is now turned to FIG. 5, which shows a high volume water inlet system 500 for use in a land-based installation 540 that could be a desalination plant, power plant, or other appropriate facility. An intake pipe 508 draws sea water 502 towards the installation 540. A microenvironment cage 505 is placed fully around the end of the intake pipe 508 so as to have its edges 511 four or more meters from intake holes 507. This arrangement means that bulk sea water 502 does not experience a high-velocity pull of the intake holes 507. The microenvironment 506 between cage 505 and intake holes 507 is clean of fish, wildlife, plastic and other debris that might clog filters associated with the intake holes. The shape and materials associated with the microenvironment cage 505 can be selected in accordance with the fixed environment associated with the land-based installation 540.

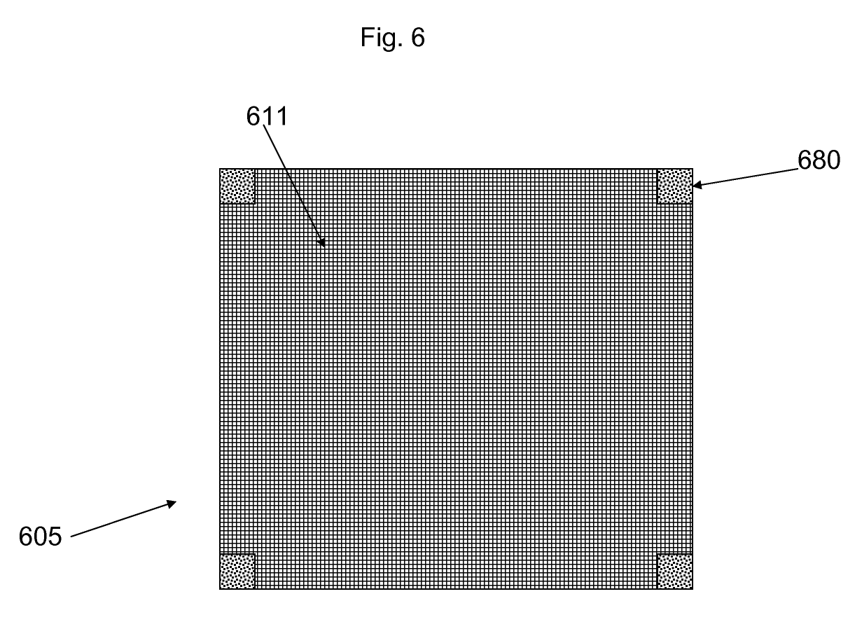

Attention is turned to FIG. 6 which shows a surface 611 of an exemplary microenvironment cage 605. The surface 611 has small holes that allow for facile water flow into the cage 605 in response to action of an associated intake pipe (not shown). The holes are of a size to allow for uninterrupted water flow with concomitant prevention of fish, wildlife, plastic and other debris from penetrating the surface of the cage 605. The cage 605 or any associated elements may include sensors 680 for monitoring the environment inside or outside the cage. Such sensors 680 could allow for responsive action, such as rotation of the cage 605 or activation of sonar, light or other repelling systems to keep fish and wildlife away from the cage surface 611.

### Fifth Embodiment

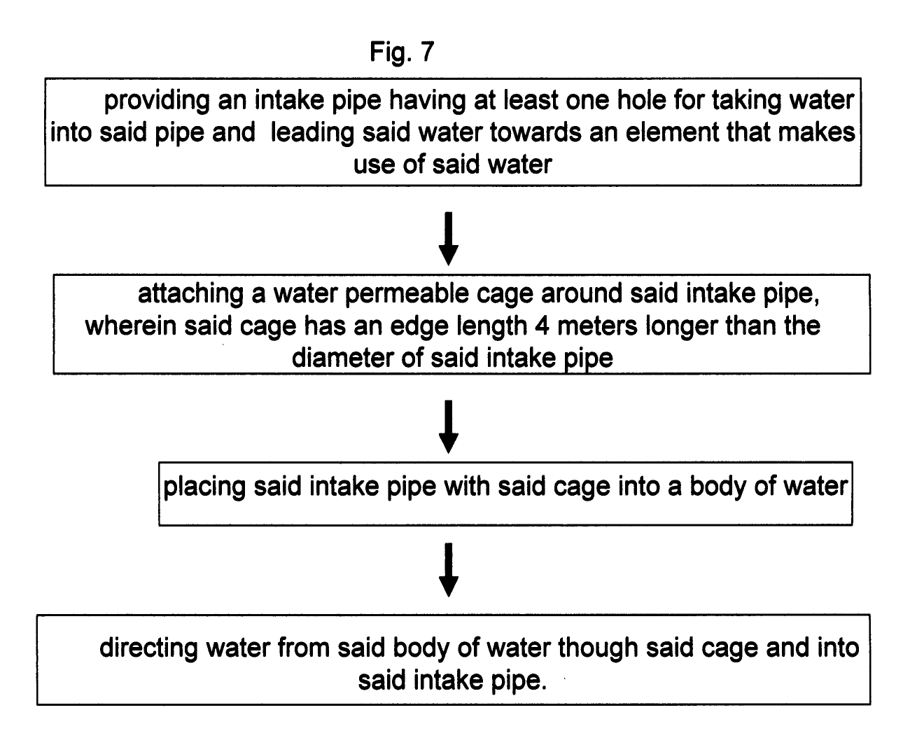

Attention is now turned to FIG. 7 which shows a method for taking in large amounts of water in an ecologically-friendly manner. The method includes the following: providing an intake pipe having at least one hole for taking water into the pipe and leading the water towards an element that makes use of the water; attaching a water permeable cage around the intake pipe, wherein the cage has an edge length 4 meters longer than the diameter of the intake pipe; placing the intake pipe with the cage into a body of water; and, directing water from the body of water though the cage and into the intake pipe. The method can include additional steps, such as but not limited to providing sensors and or optical, sonar or other elements to further enhance the performance of the system.

### Some Benefits of the Use of the Present Invention

The usefulness of the present system is typically evident in the following ways:
a) The design of a microenvironment cage 605 does not in any way slow down the flow (typically measured in tons per second) of water from bulk source and into an intake pipe.
b) A microenvironment cage protects fish and other wildlife by keeping them away from the suction forces associated with intake holes for high-volume water intake.
c) The use of sonar and light repels submarine wildlife before they may contact with the cage, thereby protecting them from any impact with metal surfaces.
d) The use of monitoring sensors allows the system through a control computer to increase or decrease the repelling systems as required, saving power in the event of naturally occurring clear water, and saving fish and other marine life in the event the surround seawater is teaming with wildlife.
e) The design of the cage means that fewer pollutants foul filters over intake holes or in the installation using the water. As such, less energy is required for moving the water and filters have longer lifetimes.
f) The rotation of the cages allows for easily cleaning, thereby eliminating the needs for human cleaning divers.
g) The cages can be removed and/or replaced easily and thus can be replaced in the case of damage or stored should a facility be closed or moved.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims.

1. A water intake system, including the following:
a high-volume water intake pipe having at least one hole for taking water into said pipe and leading said water towards an element that makes use of said water;
water filters, wherein said water filters are associated with said intake pipe; and,
a microenvironment cage, wherein said cage is physically attached to said intake pipe at a plurality of positions and includes opening for water passage from a bulk water source into a microenvironment around said intake pipe.

2. The system according to claim 1, wherein said bulk water is associated with an ocean or sea.

3. The system according to claim 1, wherein said element is a desalination facility.

4. The system according to claim 3, wherein said desalination facility is associated with a vessel.

5. The system according to claim 1, wherein said cage is cube-shaped with edge length at least four meters longer than the diameter of said intake pipe.

6. The system according to claim 1, wherein said cage is cylindrical and can be rotated.

7. The system according to claim 1, further including a sonar system associated with said cage for repelling fish and other wildlife.

8. The system according to claim 1, further including means of providing light around said cage for scaring off fish and other wildlife.

9. The system according to claim 1, wherein the outer surfaces of said cage are selected to allow for water flow into said microenvironment between said cage and said intake pipe, while fish, debris and other non-water elements are essentially kept out of said microenvironment.

10. The system according to claim 1, wherein said cage is made of a polymeric material.

11. The system according to claim 1, wherein said intake pipe is a plurality of intake pipes.

12. A method for taking in large amounts of water in an ecologically-friendly manner, including the following:
providing an intake pipe having at least one hole for taking water into said pipe and leading said water towards an element that makes use of said water;
attaching a water permeable cage around said intake pipe, wherein said cage has an edge length 4 meters longer than the diameter of said intake pipe;
placing said intake pipe with said cage into a body of water; and,
directing water from said body of water though said cage and into said intake pipe.

13. The method according to claim 12, wherein said intake pipe is associated with a desalination installation.

14. The method according to claim 13, wherein said installation is located on a vessel.

15. The method according to claim 12, wherein said body of water is an ocean.

16. The method according to claim 12, wherein said cage is built so as to prevent fish, wildlife, plastic and debris from reaching a microenvironment between said cage and said intake pipe.

17. The method according to claim 12, further including the step of rotating said cage so as to remove debris stuck to the outside of said cage.

18. A device for providing an ecologically safe microenvironment around an intake pipe of a desalination plant, including a cage placed around said intake pipe, wherein said cage is physically anchored to said intake pipe and of a design to keep fish, wildlife, plastic and other debris at least four meters from intake holes of said intake pipe.

19. The device according to claim 18, wherein said cage is attached to said intake pipe at a plurality of positions.

20. The device according to claim 18, wherein said desalination plant is associated with a vessel.

21. The system according to claim 1, wherein said intake pipe is equipped with a plurality of sensors capable of monitoring and reporting the quality of intake water to a central computer.

22. The system according to claim 1, wherein said cage is equipped with a plurality of sensors that monitor and report the quality of the intake water to a central computer.

23. The method according to claim 12, wherein said cage is equipped with a plurality of sensors capable of monitoring and reporting the quality of intake water to a central computer.

24. A water intake system, including the following:
a high-volume water intake pipe having at least one hole for taking water into said pipe and leading said water towards an element that makes use of said water;
water filters, wherein said water filters are associated with said intake pipe; and,
a rotation-capable microenvironment cage, wherein said cage is physically attached to said intake pipe at a plurality of positions and includes opening for water passage from a bulk water source into a microenvironment around said intake pipe and further including water quality sensors as well as active sonar and fiber-optic wildlife-repelling elements.
